(19) United States
(12) Patent Application Publication
(10) Pub. No.: US 2006/0095682 A1
(43) Pub. Date: May 4, 2006

(54) High-performance lock management for flash copy in n-way shared storage systems

(76) Inventors: Carlos F. Fuente, Portsmouth, Hants, Hampshire (GB); William James Scales, Portchester, Fareham (GB)

Correspondence Address: DILLION & YUDELL, LLP, 8911 N CAPITAL OF TEXAS HWY, SUITE 2110, AUSTIN, TX, 78759, US

(21) Appl. No.: 10/533,473

(22) PCT Filed: Aug. 14, 2003
(86) PCT No.: PCT/GB03/03567

§ 371 Date: Apr. 29, 2005

(30) Foreign Application Priority Data
Nov. 29, 2002 (GB) 0227825.7

(51) Int. Cl. G06F 12/00

(52) U.S. Cl. 711/141

(57) ABSTRACT

A method, system, and machine-readable medium for providing high-performance lock management for a flash copy image of a region of data in N-way shared storage systems is disclosed. According to one embodiment, a data processing system is provided which comprises a cache to store a copy of metadata specifying a coherency relationship between a region of data and a flash copy image of the region of data, wherein the metadata is subject to one or more lock protocols controlled by an owner storage controller node; and a client storage controller node, coupled with the cache, comprising an input/output performing component to receive a request to perform an input/output operation on at least one of the region of data and the flash copy image of the region of data and to perform the input/output operation utilizing the copy of the metadata.

### CROSS-REFERENCE TO RELATED APPLICATIONS

The present application hereby claims benefit of priority under 35 U.S.C. § 119 and § 365 to the previously-filed international patent application number PCT/GB2003/003567 entitled, “High-Performance Lock Management for Flash Copy in N-Way Shared Storage Systems”, filed on Aug. 14, 2003, naming Carlos Francisco Fuente and William James Scales as inventors, assigned to the assignee of the present application, and having a priority date of Nov. 29, 2002 based upon United Kingdom Patent Application No. 0227825.7 which are both herein incorporated by reference in their entirety and for all purposes.

### BACKGROUND

1. Technical Field

The present invention relates to the field of computer storage controllers, and particularly to advanced function storage controllers in n-way shared storage systems providing a Flash Copy function.

2. Description of the Related Art

In the field of computer storage systems, there is increasing demand for what have come to be described as “advanced functions”. Such functions go beyond the simple I/O functions of conventional storage controller systems. Advanced functions are well known in the art and depend on the control of metadata used to retain state data about the real or “user” data stored in the system. The manipulations available using advanced functions enable various actions to be applied quickly to virtual images of data, while leaving the real data available for use by user applications. One such well-known advanced function is ‘Flash Copy’.

At the highest level, Flash Copy is a function where a second image of ‘some data’ is made available. This function is sometimes known as Point-In-Time copy, or T0-copy. The second image's contents are initially identical to that of the first. The second image is made available ‘instantly’. In practical terms this means that the second image is made available in much less time than would be required to create a true, separate, physical copy, and that this means that it can be established without unacceptable disruption to a using application's operation.

Once established, the second copy can be used for a number of purposes including performing backups, system trials and data mining. The first copy continues to be used for its original purpose by the original using application. Contrast this with backup without Flash Copy, where the application must be shut down, and the backup taken, before the application can be restarted again. It is becoming increasingly difficult to find time windows where an application is sufficiently idle to be shut down. The cost of taking a backup is increasing. There is significant and increasing business value in the ability of Flash Copy to allow backups to be taken without stopping the business.

Flash Copy implementations achieve the illusion of the existence of a second image by redirecting read I/O addressed to the second image (henceforth Target) to the original image (henceforth Source), unless that region has been subject to a write. Where a region has been the subject of a write (to either Source or Target), then to maintain the illusion that both Source and Target own their own copy of the data, a process is invoked which suspends the operation of the write command, and without it having taken effect, issues a read of the affected region from the Source, applies the read data to the Target with a write, then (and only if all steps were successful) releases the suspended write. Subsequent writes to the same region do not need to be suspended since the Target will already have its own copy of the data. This copy-on-write technique is well known and is used in many environments.

All implementations of Flash Copy rely on a data structure which governs the decisions discussed above, namely, the decision as to whether reads received at the Target are issued to the Source or the Target, and the decision as to whether a write must be suspended to allow the copy-on-write to take place. The data structure essentially tracks the regions or grains of data that have been copied from source to target, as distinct from those that have not.

Maintenance of this data structure (hereinafter called metadata) is key to implementing the algorithm behind Flash Copy.

Flash Copy is relatively straightforward to implement within a single CPU complex (possibly with SMP processors), as is often employed within modern storage controllers. With a little more effort, it is possible to implement fault tolerant Flash Copy, such that (at least) two CPU complexes have access to a copy of the metadata. In the event of a failure of the first CPU complex, the second can be used to continue operation, without loss of access to the Target Image.

However, the I/O capability of a single CPU complex is limited. Though improving the capabilities of a single CPU complex measured in terms of either I/Os per second, or bandwidth (MB/s) has a finite limit, and will eventually impose a constraint on the performance of the using applications. This limit arises in many implementations of Flash Copy, but a good example is in Storage Controllers. A typical storage controller has a single (or possibly a redundant pair) of CPU complexes, which dictate a limit in the performance capability of that controller.

More storage controllers can be installed. But the separate storage controllers do not share access to the metadata, and therefore do not cooperate in managing a Flash Copy image. The storage space becomes fragmented, with Flash Copy being confined to the scope of a single controller system. Both Source and Target disks must be managed within the same storage controller. A single storage controller disk space might become full, while another has some spare space, but it is not possible to separate the Source and Target disks, placing the Target disk under the control of the new controller. (This is particularly unfortunate in the case of a new Flash Copy, where moving the Target is a cheap operation, as it has no physical data associated with it).

As well as constraining the total performance possible for a Source/Target pair, the constraint of single-controller storage functions adds complexity to the administration of the storage environment.

Typically, storage control systems today do not attempt to solve this problem. They implement Flash Copy techniques that are confined to a single controller, and hence are constrained by the capability of that controller.

A simple way of allowing multiple controllers to participate in a shared Flash Copy relationship is to assign one controller as the Owner of the metadata, and have the other controllers forward all read and write requests to that controller. The owning controller processes the I/O requests as if they came directly from its own attached host servers, using the algorithm described above, and completes each I/O request back to the originating controller.

The main drawback of such a system, and the reason that it is not widely used, is that the burden of forwarding each I/O request is too great, possibly even doubling the total system-wide cost, and hence approximately halving the system performance.

It is known, for example, in the area of distributed parallel database systems, to have a distributed lock management structure employing a two-phase locking protocol to hold locks on data in order to maintain any copies of the data in a coherency relation. However, two phase locking is typically time-consuming and adds a considerable messaging burden to the processing. As such, an unmodified two-phase locking protocol according to the prior art is disadvantageous in systems at a lower level in the software and hardware stack, such as storage area networks having distributed storage controllers where the performance impact of the passing of locking control messages is even more significant than it is at the database control level.

It would therefore be desirable to gain the advantages of distributed lock management in a Flash Copy environment while incurring the minimum lock messaging overhead.

### BRIEF SUMMARY

The present invention accordingly provides a method, system, and machine-readable medium for providing high-performance lock management for a flash copy image of a region of data in N-way shared storage systems. According to one embodiment, a data processing system is provided which comprises a cache to store a copy of metadata specifying a coherency relationship between a region of data and a flash copy image of the region of data, wherein the metadata is subject to one or more lock protocols controlled by an owner storage controller node; and a client storage controller node, coupled with the cache, comprising an input/output performing component to receive a request to perform an input/output operation on at least one of the region of data and the flash copy image of the region of data and to perform the input/output operation utilizing the copy of the metadata.

According to another embodiment, a method is provided which comprises storing a copy of metadata specifying a coherency relationship between a region of data and a flash copy image of the region of data within a cache, wherein the metadata is subject to one or more lock protocols controlled by an owner storage controller node; receiving a request to perform an input/output operation on at least one of the region of data and the flash copy image of the region of data at a client storage controller node; and performing the input/output operation utilizing an input/output performing component of the client storage controller node and the copy of the metadata.

According to yet another embodiment, a machine-readable medium is provided having a plurality of instructions executable by a machine embodied therein, wherein the plurality of instructions, when executed, cause said machine to perform the method previously described herein.

The foregoing is a summary and thus contains, by necessity, simplifications, generalizations and omissions of detail; consequently, those skilled in the art will appreciate that the summary is illustrative only and is not intended to be in any way limiting. As will also be apparent to one of skill in the art, the operations disclosed herein may be implemented in a number of ways including implementation in hardware, i.e. ASICs and special purpose electronic circuits, and such changes and modifications may be made without departing from this invention and its broader aspects. Other aspects, inventive features, and advantages of the present invention, as defined solely by the claims, will become apparent in the non-limiting detailed description set forth below.

### BRIEF DESCRIPTION OF THE DRAWINGS

A preferred embodiment of the present invention will now be described by way of example only, with reference to the accompanying drawings, in which:

FIG. 1 is a flow diagram illustrating one embodiment of a two-phase locking scheme using lock messages to control coherency between a region of data and a Flash Copy image of the data;

FIG. 2 shows system components of a system according to one embodiment of the present invention; and

FIG. 3 shows additional process operations of an alternative embodiment of the present invention.

### DETAILED DESCRIPTION OF AN ILLUSTRATIVE EMBODIMENT

For better understanding of the presently described illustrative embodiments of the present invention, it is necessary to describe the use of two-phase lock messaging to co-ordinate activity between plural storage controllers (or nodes) in an n-way storage system.

As an example, consider an n-way system implementing Flash Copy. Assume every node has access to the storage managed by the co-operating set of n nodes. One of the nodes is designated as an owner (process block 102) for metadata relating to all I/O relationships of a region of storage. The other nodes are designated as clients. In one embodiment, one of the client nodes is further designated as a backup owner and maintains a copy of the metadata in order to provide continuous availability in the event of a failure of the owner node.

Consider a host I/O request arriving (process block 104) at a particular client node (‘C’). Suppose that the host I/O request is either a Read or Write of the Target disk, or possibly a Write of the Source disk. Client C begins processing by suspending (process block 106) the I/O. C then sends (process block 108) a message REQ to the Owner node O, asking if the grain has been copied.

On receipt of message REQ, O inspects its own metadata structures. If O finds that the region has already been copied, O replies (process block 110) with a NACK message. If O finds that the region has not already been copied, it places a lock record against the appropriate metadata for the region within its own metadata structures, and replies (process block 112) with a GNT message. The lock record is required to ensure compatibility between the request just received and granted, and further requests that might arrive affecting the same metadata while the processing at C continues. Various techniques to maintain the lock record and to define the compatibility constraints as if the I/O had been received locally by O may be implemented in embodiments of the present invention.

On receipt of a NACK message, C unpends (process block 114) the original I/O request. On receipt of the GNT message, C continues (process block 116) by performing the data transfer or transfers required by the Flash Copy algorithm. In the case of a Target Read, this means performing the read to the source disk. Some time later, C will indicate completion (process block 118) of the read request, and will issue (process block 120) an UNL message to O, at the same time as completing the original I/O request to the host system that issued it.

O, on receipt of an UNL message, removes (process block 122) the lock record from its metadata table, thus possibly releasing further I/O requests that were suspended because of that lock. According to one embodiment, O then delivers (process block 124) a UNLD message to C, allowing C to reuse the resources associated with the original request. This is, however, not required by the Flash Copy algorithm itself.

In the case of a write (to either Target or Source) C performs the copy-on-write (process block 127). Having completed all steps of the copy-on-write, and with the original write I/O request still suspended, C issues (process block 126) an UNLC request to O. O, on receipt of an UNLC message, marks (process block 128) in metadata the region affected as having been copied, removes (process block 130) the lock record, informs (process block 132) any waiting requests that the area has now been copied, and then issues (process block 134) an UNLD message to C. C, on receipt of a UNLD message, releases (process block 136) the suspended write operation, which will some time later complete, and then C completes (process block 138) the write operation to the host. According to another embodiment of the present invention, recovery paths are required to cater for the situation where a disk I/O fails, or the messaging system fails, or a node fails.

The above description was from the point of view of a single I/O, and a single Client C. Embodiments of the present invention may be implemented however in the presence of multiple I/Os, from multiple client nodes, with O continuing to process all requests utilizing the same algorithm.

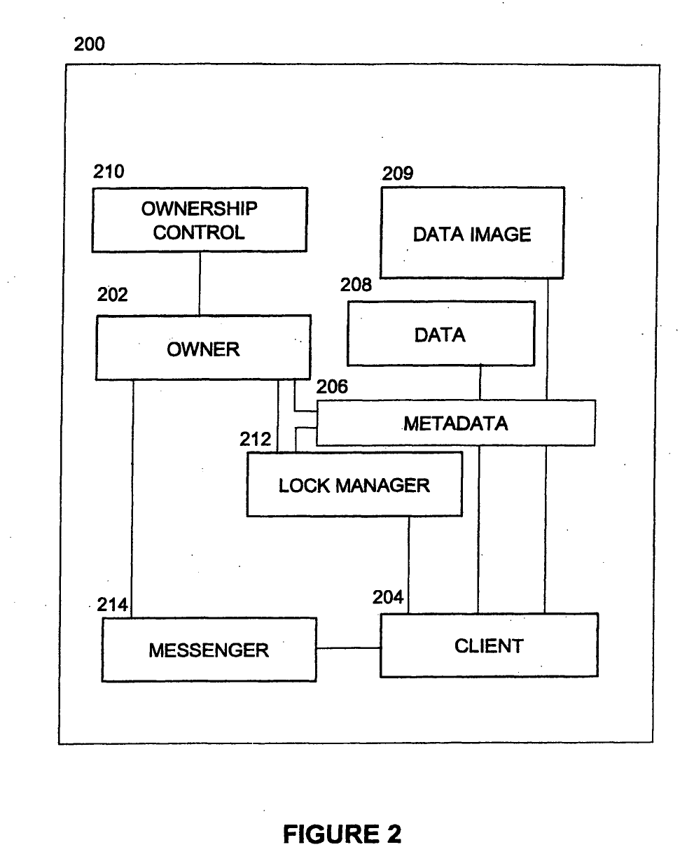

Turning now to FIG. 2, there is shown an apparatus in accordance with an embodiment of the present invention. The depicted apparatus is embodied within a storage controller network 200 comprising an Owner 202, a Client 204 I/O performing component, a portion of metadata 206 relating to data 208 held under the control of the storage network, a copy 209 of the data 208, and communication means. The apparatus includes an ownership assignment component 210 to assign ownership of metadata to Owner 202, and a lock management component 212 operable to control locking at a metadata 206 level during I/O activity to ensure coherency with any copy 209. Included also is a messaging component 214 at Owner 202. In the depicted embodiment, messaging component 214 is operable to pass one or more messages between Client 204 and Owner 202 to request a response regarding a metadata state, grant a lock, request release of a lock, and/or signal that a lock has been released. Client 204 is similarly operable in the illustrated embodiment to perform I/O on data whose metadata is owned by any owner (e.g., Owner 202), subject to Client's 204 compliance with the lock protocols at the metadata level controlled by that owner.

The system and method thus described are capable of handling distributed lock management in an n-way shared storage controller network, but require considerable messaging overhead in the system to operate. This is not burdensome in systems containing relatively few controllers or where there is relatively little activity, but in other modern storage systems, such as very large storage area networks, there are likely to be many controllers and a very high level of storage activity. Under such circumstances, the avoidance of unnecessary messaging overhead would be advantageous.

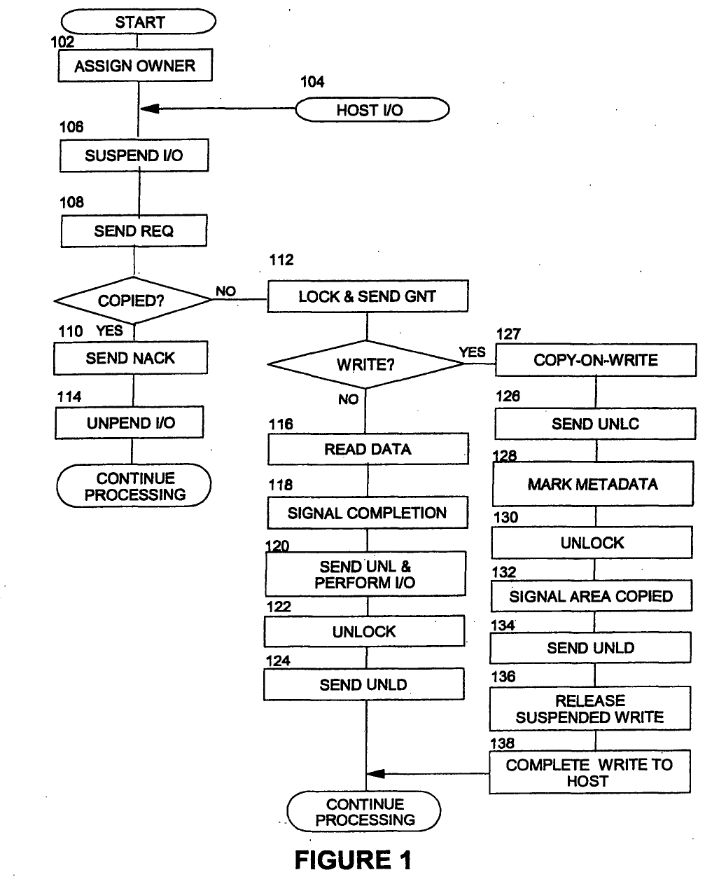

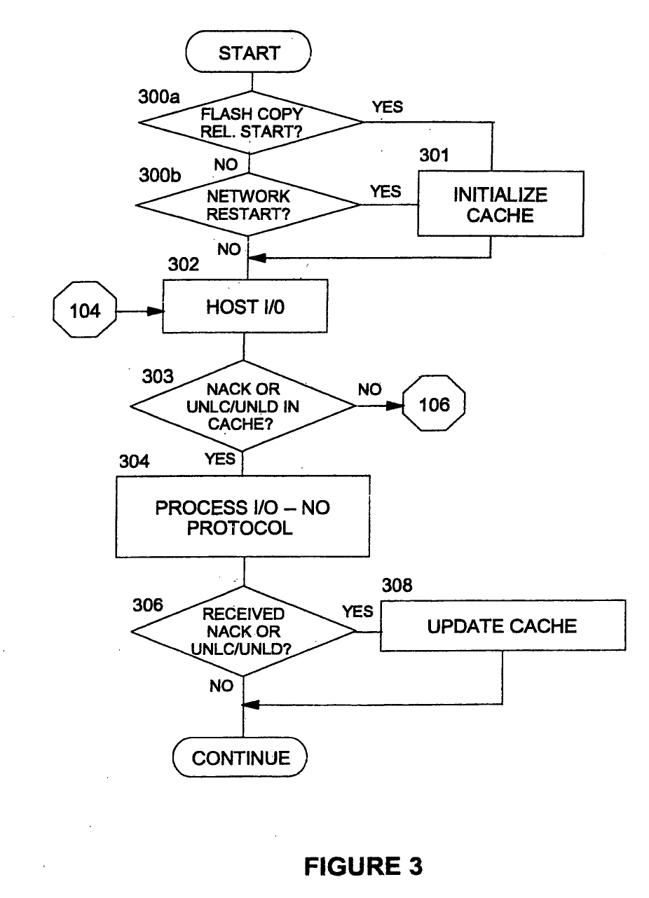

Thus, in another embodiment of the present invention, each client node is provided with the ability to maintain information which records the last response received from an Owner. Specifically (described in terms of additions to FIG. 1 according to FIG. 3), a client node C is permitted to cache (process block 308) data indicating a NACK message was received (after process block 114 of FIG. 1), or that itself issued and had acknowledged an UNLC/UNLD message pair (at process block 126 and after process block 134 of FIG. 1).

On receipt (process block 302) of a host I/O request as at process block 104 of FIG. 1, Client C now applies a modified lock control algorithm, as follows. C first inspects its cached data (process block 303), to see if it has a positive indication that the region affected has already been copied. If it has, then it continues (process block 304) with the I/O without sending any protocol messages to O. If the cache contains no such positive indication, the unmodified protocol described above and illustrated herein at process block 106 et seq. of FIG. 1) is used. The receipt (process block 306) of a NACK or an UNLC/UNLD pair causes a caching of information to be updated (process block 308), and subsequent I/Os that affect that region, finding this information in the cache (process block 303), can proceed (process block 304) without issuing any protocol messages.

The term ‘pessimistic cache’ is sometimes used to describe the approach needed in the presently described embodiment of the present invention. This means that a client need not be fully up-to-date with the Owner's metadata; a client may believe an area needs to be copied, and be corrected by the owner (NACK) to say it does not. However, a client should not believe that an area has been copied when a corresponding owner knows it has not.

The lock caching of the presently described embodiment requires certain changes to the client for correct operation. First, the cache must be initialized (process block 301) (e.g., to indicate that all regions must be copied) each time a Flash Copy relationship is started (process block 300a). This might be driven in a number of ways, but a message from Owner to Client is the most straightforward to implement. Second, any time a client node might have missed a message (process block 300b) indicating that the cache has been reinitialized (perhaps because of a network disturbance), the client must assume the worst case and reinitialize (process block 301) or revalidate its cache.

Further extensions and variations are possible, as will be clear to one skilled in the art. For example, the cached information is discardable, as it can always be recovered from the owner node, which has the only truly up-to-date copy. Thus, the client could have less metadata space allocated for caching information than would be required to store all the metadata held on all the nodes. The clients could then rely on locality of access for the I/Os they process to ensure that they continue to benefit from the caching of the lock message information.

In a further extended embodiment, a NACK message (and also the GNT or UNLD messages) can carry back more information than that relating to the region being directly processed by the REQ/GNT/UNLC/UNLD messages. Information concerning neighboring regions that have also been cleaned can be sent from owners to clients.

It will be appreciated that the method described above will typically be carried out in software running on one or more processors (not shown), and that the software may be provided as a computer program element carried on any suitable data carrier (also not shown) such as a magnetic or optical computer disc. The channels for the transmission of data likewise may include storage media of all descriptions as well as signal carrying media, such as wired or wireless signal media.

The present invention may suitably be embodied as a computer program product for use with a computer system. Such an implementation may comprise a series of computer readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analog communications lines, or intangibly using wireless techniques, including but not limited to microwave, infrared or other transmission techniques. The series of computer readable instructions may embody all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

It will be appreciated that various modifications to the embodiment described above will be apparent to a person of ordinary skill in the art.

What is claimed is:

1. A data processing system comprising:
a cache to store a copy of metadata specifying a coherency relationship between a region of data and a flash copy image of said region of data, wherein said metadata is subject to one or more lock protocols controlled by an owner storage controller node; and
a client storage controller node, coupled with said cache, comprising an input/output performing component to receive a request to perform an input/output operation on at least one of said region of data and said flash copy image of said region of data and to perform said input/output operation utilizing said copy of said metadata.

2. The data processing system of claim 1, further comprising:
a messaging component, coupled between said client storage controller node and said owner storage controller node, to pass at least one of: a message to request a lock, a message to grant a lock, a message to request release of a lock, and a message to signal that a lock has been released.

3. The data processing system of claim 1, wherein said copy of said metadata comprises,
a previous positive confirmation that said region of data and a flash copy comprising said flash copy image of said region of data are consistent.

4. The data processing system of claim 3, wherein said input/output performing component is operable to discard said previous positive confirmation.

5. The data processing system of claim 3, wherein said previous positive confirmation further comprises
a positive confirmation that a further region of data, contiguous with said region of data, is consistent with said flash copy.

6. The data processing system of claim 1, further comprising:
a cache storage area to store said cache, wherein
said input/output performing component is operable to selectively discard said copy of said metadata, and
said cache storage area is reduced as a result of said copy of said metadata being discarded.

7. A method comprising:
storing a copy of metadata specifying a coherency relationship between a region of data and a flash copy image of said region of data within a cache, wherein said metadata is subject to one or more lock protocols controlled by an owner storage controller node;
receiving a request to perform an input/output operation on at least one of said region of data and said flash copy image of said region of data at a client storage controller node; and
performing said input/output operation utilizing an input/output performing component of said client storage controller node and said copy of said metadata.

8. The method of claim 7, further comprising:
transferring at least one of: a message to request a lock, a message to grant a lock, a message to request release of a lock, and a message to signal that a lock has been released between said client storage controller node and said owner storage controller node utilizing a messaging component.

9. The method of claim 7, wherein said copy of said metadata comprises,
a previous positive confirmation that said region of data and a flash copy comprising said flash copy image of said region of data are consistent.

10. The method of claim 9, further comprising:
discarding said previous positive confirmation utilizing said input/output performing component.

11. The method of claim 9, wherein said previous positive confirmation further comprises
a positive confirmation that a further region of data, contiguous with said region of data, is consistent with said flash copy.

12. The method of claim 7, further comprising:
selectively discarding said copy of said metadata to maintain a reduced cache storage area including said cache.

13. A machine-readable medium having a plurality of instructions executable by a machine embodied therein, wherein said plurality of instructions, when executed, cause said machine to perform a method comprising:
storing a copy of metadata specifying a coherency relationship between a region of data and a flash copy image of said region of data within a cache, wherein said metadata is subject to one or more lock protocols controlled by an owner storage controller node; and
receiving a request to perform an input/output operation on at least one of said region of data and said flash copy image of said region of data at a client storage controller node; and
performing said input/output operation utilizing an input/output performing component of said client storage controller node and said copy of said metadata.

14. The machine-readable medium of claim 13, said method further comprising:
transferring at least one of: a message to request a lock, a message to grant a lock, a message to request release of a lock, and a message to signal that a lock has been released between said client storage controller node and said owner storage controller node utilizing a messaging component.

15. The machine-readable medium of claim 13, wherein said copy of said metadata comprises,
a previous positive confirmation that said region of data and a flash copy comprising said flash copy image of said region of data are consistent.

16. The machine-readable medium of claim 15, said method further comprising:
discarding said previous positive confirmation utilizing said input/output performing component.

17. The machine-readable medium of claim 15, wherein said previous positive confirmation further comprises
a positive confirmation that a further region of data, contiguous with said region of data, is consistent with said flash copy.

18. The machine-readable medium of claim 13, said method further comprising:
selectively discarding said copy of said metadata to maintain a reduced cache storage area including said cache.
